(19) United States
(12) Patent Application Publication
(10) Pub. No.: US 2010/0176279 A1
(43) Pub. Date: Jul. 15, 2010

(54) METHODS AND MATERIALS FOR DETECTING LIGHT RELEASED FROM A LABELING MATERIAL

(75) Inventor: Benny Wing Hung Lai, Fremont, CA (US)

Correspondence Address: K&L Gates LLP, P.O. Box 1135, CHICAGO, IL, 60690, US

(73) Assignee: ALVERIX, INC., San Jose, CA (US)

(21) Appl. No.: 12/353,621

(22) Filed: Jan. 14, 2009

(51) Int. Cl. H01J 40/14

(52) U.S. Cl. 250/216

(57) ABSTRACT

The present disclosure relates generally to methods and materials for detecting light absorbed or released from a labeling material. In particular, the present disclosure provides a detection architecture and devices employing the detection architecture for real-time subtraction of a background light from a light absorbed or released from a labeling material. Devices employing the detection architecture of the present disclosure may be used in methods for detecting a light absorbed or released from a labeling material by contacting a labeling material with a light source, wherein the fluorescent label absorbs or releases a first light; detecting the first light after the light source is enabled with a detector, wherein the detector produces a first signal from the first light; turning on a first switch at a first time for a fixed interval to receive the first signal from the first light; detecting a background noise with a detector after the light source is disabled, wherein the detector produces a second signal from the background noise; turning on a second switch at a second time for a fixed interval to receive the second signal from the second light; feeding the first signal and the second signal into a differential amplifier, wherein the differential amplifier subtracts the second signal from the first signal and produces an output signal; and measuring the output signal emitted from the differential amplifier.

### BACKGROUND

Assay test kits currently are available for testing a wide variety of medical and environmental conditions or compounds, such as a hormone, a metabolite, a toxin, or a pathogen-derived antigen. Most commonly these tests are used for medical diagnostics either for home testing, point of care testing, or laboratory use. For example, lateral flow tests are a form of immunoassay in which the test sample flows along a solid substrate via capillary action. Some tests are designed to make a, quantitative determination, but in many circumstances all that is required is a positive/negative qualitative indication. Examples of such qualitative assays include blood typing, most types of urinalysis, pregnancy tests, and AIDS tests. For these tests, a visually observable indicator such as the presence of agglutination or a color change is preferred.

In the field of immunoassay detection, the presence of an antigen is inferred by the presence of specially created antibodies which contain reflectance or fluorescence labeling materials. The classical detection method of these labels using a PIN diode detector in conjunction with a transimpedance amplifier (TIA) as shown in FIG. 1. The labeling material 25 is illuminated with a light source, such as with a laser or LED 20, and the amount of fluorescence or reflectance is then detected with the PIN detector 30, and its signal is amplified with the TIA 40. For the fluorescence label case, higher sensitivity could be achieved when an optical filter 27 is added to attenuate the light component, and allows the fluorescence signal, which is re-radiated at a slightly higher wavelength, to pass through to the PIN detector 30. The output 55 is usually further processed with an analog-to-digital converter (ADC) and a micro-controller to drive a user-friendly interface such as an LCD display.

One component which limits the lower limit of the detection sensitivity may be the presence of the background signal. This signal is a combination of the background light present such as ambient light, dark current of the PIN diode, noise of the electronics used to drive the light source, and the noise of the electronic circuitry of the detector and amplifiers. The goal is to minimize the effects of these components to achieve higher sensitivity. One method of background signal subtraction is to perform a calibration step with the light source turned off, and then take a background reading. During the normal course of detection, this background reading is then subtracted mathematically to yield the actual result. However, this method's sensitivity is limited by the resolution of the ADC, requiring a high order ADC with great expense. Moreover, the drift of the components over time due to environmental conditions such as temperature and power supply drifts. Another drawback to this approach is that the level of the background signal could cause the amplifiers to saturate.

### SUMMARY

The present disclosure provides methods and materials for detecting light absorbed, as from a reflective labeling material, or released, as from a fluorescence labeling material.

The present disclosure provides an architecture that may be employed in devices for detection of a light absorbed or released from a labeling material, the device comprising: a light source (e.g., a controlled light source such as a laser or LED) to illuminate the labeling material, a photodetector, wherein the photodetector detects the light absorbed or released from the labeling material; a first analog switch, wherein after the light source is enabled, the first analog switch is turned on at a first time for a finite interval, receives a signal from the photodetector and generates a first signal; a second analog switch, wherein after the light is disabled, the second analog switch is turned on at a second time for a finite interval and generates a second signal; and a differential amplifier that receives the first signal and the second signal to produce an output signal. This sequence may be repeated to yield multiple first and second signals, which may then be averaged before the differential amplifier to yield a clean, stable output signal.

In an embodiment, the device further comprises a transimpedance amplifier for amplifying the signal produced by the photodetector.

In an embodiment, the device further comprises an RC filter network after the first switch to average the detected test signal. In an embodiment, the device further comprises an RC filter network after the second switch to average the detected background signal. In an embodiment, the device further comprises an RC filter network after the first switch and after the second switch.

In an embodiment, the device further comprises a resistor after the transimpedance amplifier.

In an embodiment, the device further comprises an analog to digital converter and a microcontroller to drive a user friendly interface. In an embodiment, the user friendly interface is an LCD display.

In an embodiment, the device further comprises a capacitor across the input of the differential amplifier.

In an embodiment, the light source is a laser. In an embodiment, the light source is an LED.

In an embodiment, the photodetector is a PIN photo diode.

In an embodiment, material when the controlled light source is enabled, the first analog switch receives a signal from the detector corresponding to the light absorbed or released from a labeling. In an embodiment, when the controlled light source is disabled, the second analog switch receives a signal from the detector corresponding to background signal.

In an embodiment, the background signal is selected from the group consisting of: background light, dark current of the PIN diode, noise of the electronics used to drive the light source, and the noise of the electronic circuitry of the detector and amplifiers or combinations thereof.

In an embodiment, the labeling material is a fluorescent material. In an embodiment, the labeling material is a reflective material.

The present disclosure also provides methods for detecting a light absorbed or released from a labeling material, the method comprising: illuminating a labeling material with a light source (e.g., a controlled light source such as a laser or an LED), wherein the labeling material absorbs or releases a first light; detecting the first light with a detector, wherein after the controlled light source is enabled, the detector produces a first signal from the first light; enabling a first switch at a first time for a finite interval to receive the first signal from the first light; detecting a background signal with a detector, wherein after the controlled light source is disabled, the detector produces a second signal from the background signal; enabling a second switch at a second time for a finite interval to receive the second signal from the second light; feeding the first signal and the second signal into a differential amplifier, wherein the differential amplifier subtracts the second signal from the first signal and produces an output signal; and measuring the output signal emitted from the differential amplifier. This sequence may be repeated including, for example, with the same time intervals to yield multiple first and second signals.

In an embodiment, the first switch detects the light emitted by the fluorescent label. In an embodiment, the background signal is selected from the group consisting of: background light, dark current of the PIN diode, noise of the electronics used to drive the light source, and the noise of the electronic circuitry of the detector and amplifiers or combinations thereof.

In an embodiment, the labeling material is a fluorescent material. In an embodiment, the labeling material is a reflective material.

In an embodiment, the test light and the background light are detected by the same detector. In an embodiment, the test light and the background light are detected by different detectors.

In an embodiment, the light source is a laser. In an embodiment, the light source is an LED.

In an embodiment, the light is pulsed.

In an embodiment, the first switch is turned on during fluorescence decay. In an embodiment, the second switch is turned on before or after the fluorescent label is illuminated with the light source.

In an embodiment, the output of the first and the second analog switches are fed into low-pass RC filters.

In an embodiment, a third filter is added across the imputs of the amplifier for further filtering.

The present disclosure also provides methods for conducting an assay, the method comprising: applying a test sample with at least one analyte to the assay; binding a labeling material to the analyte; contacting the labeling material with a light source (e.g., a controlled light source such as a laser or an LED), wherein the labeling material absorbs or releases a first light; detecting the first light with a detector, wherein the detector produces a first signal from the first light; enabling a first switch at a first time for a finite interval to receive the first signal from the first light; detecting background signal with a detector, wherein the detector produces a second signal from the background signal; enabling a second switch at a second time for a finite interval to receive the second signal from the second light; feeding the first signal and the second signal into a differential amplifier, wherein the differential amplifier subtracts the second signal from the first signal and produces an output signal; and measuring the output signal emitted from the differential amplifier. This sequence may be repeated including, for example, with the same time intervals to yield multiple first and second signals.

In an embodiment, the assay is a lateral flow assay.

In an embodiment, the first switch detects the light emitted by the fluorescent label.

In an embodiment, the background noise is selected from the group consisting of: background light, dark current of the PIN diode, noise of the electronics used to drive the light source, and the noise of the electronic circuitry of the detector and amplifiers or combinations thereof.

In an embodiment, the labeling material is a fluorescent material. In an embodiment, the labeling material is a reflective material.

In an embodiment, the test light and the background light are detected by the same detector. In an embodiment, the test light and the background light are detected by different detectors.

In an embodiment, the light source is a laser. In an embodiment, the light source is a LED.

In an embodiment, the light is pulsed.

In an embodiment, the first switch is turned on during fluorescence decay. In an embodiment, the second switch is turned on before or after the fluorescent label is contacted with the light source.

In an embodiment, the output of the first and the second analog switches are fed into low-pass RC filters.

In an embodiment, a third filter is added across the imputs of the amplifier for further filtering.

Additional features and advantages are described herein, and will be apparent from, the following Detailed Description and figures.

### BRIEF DESCRIPTION OF THE FIGURES

FIG. 1 depicts a classical architecture for detection of a label.

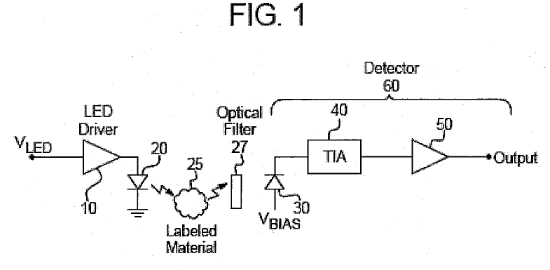

FIG. 2 shows an embodiment of the present disclosure.

FIG. 3 shows an embodiment of the present disclosure

FIG. 4 depicts a timing diagram for the detection of light released from a labeling material.

FIG. 5 depicts a timing diagram for detection of long decay fluorescence materials.

### DETAILED DESCRIPTION

The present disclosure provides methods and materials for detecting light absorbed (e.g., reflectance) or released (e.g., fluorescence) from a labeling material. Specifically, the disclosure provides an architecture for an assay detection system that allows for the real-time subtraction of a background signal detected when a controlled illumination source is disabled, from a signal detected from the labeling material when the illumination source is enabled.

The systems, including devices of the present disclosure allow for the detection of a light absorbed or released from a labeling material, the device comprising: a light source (e.g., a controlled light source such as a laser or LED), a photodetector, wherein the photodetector detects a background light or the light absorbed or released from the labeling material; a first analog switch, wherein after the controlled light source is enabled, the first analog switch is turned on at a first time for a fixed interval, receives a signal from the photodetector and generates a first signal; a second analog switch, wherein after the controlled light source is disabled, the second analog switch is turned on at a second time for a fixed interval and generates a second signal; and a differential amplifier that receives the first signal and the second signal to produce an output signal. Such devices may be used for detecting a light absorbed or released from a labeling material, the method comprising: contacting a labeling material with a light source, wherein the reflective or fluorescent label absorbs or releases a first light respectively; detecting the first light with a detector, wherein after the controlled light source is enabled, the detector produces a first signal from the first light; a first switch is turned on at a first time for a finite interval to receive the first signal from the first light; detecting a background signal with a detector, wherein after the controlled light is disabled, the detector produces a second signal from the background signal; a second switch is turned on at a second time for a finite interval to receive the second signal from the second light; feeding the first signal and the second signal into a differential amplifier, wherein the differential amplifier subtracts the second signal from the first signal and produces an output signal; and measuring the output signal emitted from the differential amplifier. This sequence may be repeated to yield multiple averaged signals before the differential amplifier to yield a clean, stable signal, which may then be converted by an ADC converter. Since the background signal subtraction occurs before the ADC conversion using analog means, a high-order (e.g., expensive) ADC may not be required.

The present disclosure provides an architecture for use in detectors employed in immunoassay detection. Such detectors may be employed to subtract in real time a background light from a light released from a labeling material.

The devices of the present disclosure comprise a light source for excitation of a labeling material (e.g., a fluorescent material and/or a reflective material). A light source may include a laser and/or a LED. Light absorbed or released from a labeling material or background signal may be detected with a photodetector such as a PIN photo diode and fed to a first and/or a second switch, respectively. Background signal may include background light, dark current of the PIN diode, noise of the electronics used to drive the light source, and the noise of the electronic circuitry of the detector and amplifiers or combinations thereof. The signals from the first and second switch may be fed into a differential amplifier with an output signal equal to the background signal subtracted from the signal corresponding to the light detected from the labeling material. Optionally, the device may further comprise a transimpedance amplifier for amplifying the signal produced by the photodetector, an RC filter network after the first switch to detect the test light, or an RC filter network after the second switch to detect the background signal. The device may further comprise an analog to digital converter and a microcontroller to drive a user friendly interface. The user-friendly interface may be an LCD display.

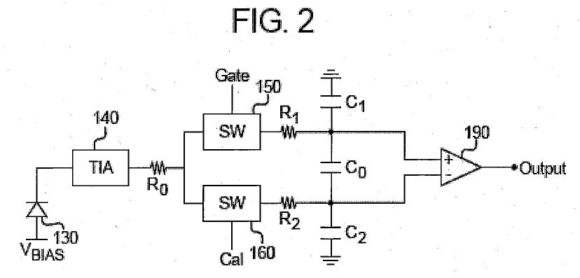

A first embodiment of the proposed detector architecture is shown in FIG. 2. The detector may comprise a PIN photo diode 130 connected to a transimpedance amplifier (TIA) 140, which may be fed into a first analog switch 150 and a second analog switch 160 via an optional resistor RO. These switches are driven by signals from acquisition of a background light and a light release from a labeling material (e.g., gate and cal, respectively). The output of these switches 155 and 165 may be fed into low-pass RC filters consisting of R1, R2, C1 and C2. The outputs 175, 185 of the filters may then be fed into a differential amplifier 190 which generates a final output signal. Optionally, a third capacitor CO is added across the inputs of the amplifier for further filtering.

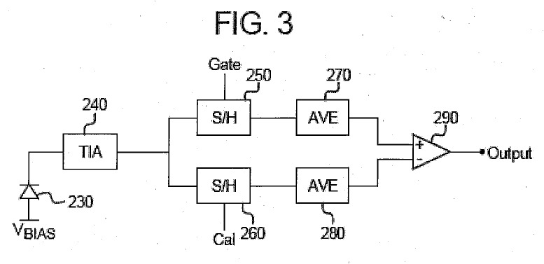

A second alternate embodiment of the disclosure is shown in FIG. 3. Here the analog switches 150 and 160 of FIG. 2 are replaced with sample-and-hold blocks 250 and 260, and the explicit low-pass RC filters of FIG. 2 are replaced by averaging functional blocks 270 and 280. Functionally, both the first and second embodiment are identical, with the second embodiment describing a more general form.

The present disclosure also provides methods for detecting a light released from a labeling material, the method comprising: contacting a labeling material with a light source, wherein the fluorescent label releases a first light; detecting the first light with a detector, wherein the detector produces a first signal from the first light; a first switch is turned on at a first time for a finite interval to receive the first signal from the first light; detecting background signal with a detector, wherein the detector produces a second signal from the background signal; a second switch is turned on at a second time for a finite interval to receive the second signal from the second light; feeding the first signal and the second signal into a differential amplifier, wherein the differential amplifier subtracts the second signal from the first signal and produces an output signal; and measuring the output signal emitted from the differential amplifier.

The devices of the present disclosure may be employed in methods for conducting an assay, the method comprising: applying a test sample with at least one analyte to the assay; binding a labeling material to the analyte; contacting the labeling material with a light source, wherein the fluorescent label releases a first light; detecting the first light with a detector, wherein the detector produces a first signal from the first light; opening a first switch at a first time to receive the first signal from the first light; detecting background noise with a detector, wherein the detector produces a second signal from the background signal; opening a second switch at a second time to receive the second signal from the second light; feeding the first signal and the second signal into a differential amplifier, wherein the differential amplifier subtracts the second signal from the first signal and produces an output signal; and measuring the output signal emitted from the differential amplifier.

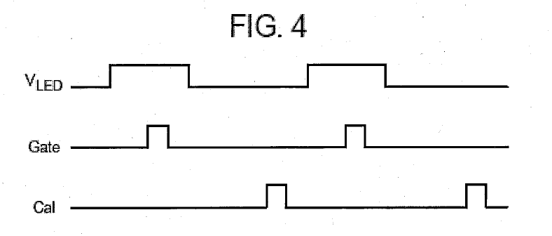

The timing diagram for acquisition of a signal produced by a light released from a labeling material and a signal produced by a background light along with the VLED excitation signal is shown in FIG. 4. When a light source including a laser or LED light is pulsed on (VLED is high), a first switch SW1 is turned on for a finite interval (referring to FIG. 2) to acquire a signal produced by a light absorbed or released from a labeling material (e.g., a gate signal) and charges a RC filter network during when a signal is detected by a transimpedance amplifier (TIA). When the light source is off (VLED is low), a second switch SW2 is turned on for a finite interval to acquire a background signal (e.g., a calibration signal) and charges a RC filter network during when a signal is detected by the TIA.

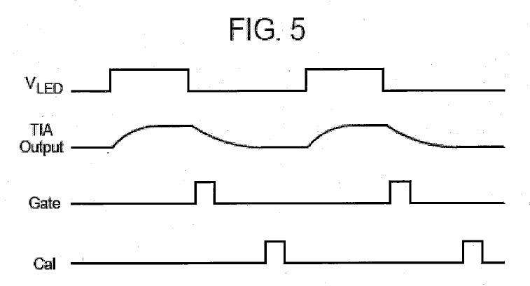

One well-known method of detection which could yield a very high level of sensitivity is to detect the florescence decay. This timing is such that during the detection, the main light source is turned off, thus eliminating the background light component of the noise. If the speed of the detector is fast compared to the decay of the florescent label, then the florescence could be detected before it decays. The timing of the detection window is simply shifted to decay window, as shown in FIG. 5. After light source is tuned off (VLED is low), the switch SW1 may be turned on momentarily (Gate signal) to detect the signal of the fluorescence decay. After the fluorescence signal has fully decayed, the rest of the background signal components are detected by momentarily turning on SW2 (Cal signal), and the system functions as before. Since the gating occurs when the light source is turned off, the detection optical may not be required to further reduce system cost.

The methods of the present disclosure are preferably used with an immunoassay device. One or more analytes bound to an antibody on the surface of the immunoassay device may be detected and subsequently quantitated.

Exemplary assays contemplated for use with the methods of the present disclosure include lateral flow assay test strips. Lateral flow assay test strips may comprise a membrane system that forms a single fluid flow pathway along the test strip. The membrane system may include one or more components that act as a solid support for immunoreactions. For example, porous, bibulous or absorbent materials may be placed on a strip such that they partially overlap, or a single material can be used, in order to conduct liquid along the strip. The membrane materials may be supported on a backing, such as a plastic backing. In a preferred embodiment, the test strip includes a glass fiber pad, a nitrocellulose strip and an absorbent cellulose paper strip supported on a plastic backing.

Antibodies that react with the target analyte and/or a detectable label system are immobilized on the solid support. The antibodies may be bound to the test strip by adsorption, ionic binding, van der Waals adsorption, electrostatic binding, or by covalent binding, by using a coupling agent, such as glutaraldehyde. For example, the antibodies may be applied to the conjugate pad and nitrocellulose strip using standard dispensing methods, such as a syringe pump, air brush, ceramic piston pump or drop-on-demand dispenser. In a preferred embodiment, a volumetric ceramic piston pump dispenser may be used to stripe antibodies that bind the analyte of interest, including a labeled antibody conjugate, onto a glass fiber conjugate pad and a nitrocellulose strip. The test strip may or may not be otherwise treated, for example, with sugar to facilitate mobility along the test strip or with water-soluble non-immune animal proteins, such as albumins, including bovine (BSA), other animal proteins, water-soluble polyamino acids, or casein to block non-specific binding sites.

Any antibody, including polyclonal or monoclonal antibodies, or any fragment thereof, such as the Fab fragment, that binds the analyte of interest, is contemplated for use herein.

An antibody conjugate containing a detectable label may be used to bind the analyte of interest. The detectable label used in the antibody conjugate may be any physical or chemical label capable of being detected on a solid support using a reader, preferably a reflectance reader, and capable of being used to distinguish the reagents to be detected from other compounds and materials in the assay.

Suitable antibody labels (e.g., labeling materials) are well known to those of skill in the art and include, but are not limited to, enzyme-substrate combinations that produce color upon reaction, colored particles, such as latex particles, colloidal metal or metal or carbon sol labels, fluorescent labels, and liposome or polymer sacs, which are detected due to aggregation of the label. In an embodiment, colloidal gold is used in the labeled antibody conjugate. The label may be derivatized for linking antibodies, such as by attaching functional groups, such as carboxyl groups to the surface of a particle to permit covalent attachment of antibodies. Antibodies may be conjugated to the label using well known coupling methods.

The assay test strip may be any conventional lateral flow assay test strip such as disclosed in EP 291194 or U.S. Pat. No. 6,352,862. The test strip may comprise a porous carrier containing a particulate labelled specific binding reagent and an unlabelled specific binding reagent. The light sources and corresponding photodetectors are preferably so aligned such that during use, light from the light source or sources falls upon the respective zones on the porous carrier and is reflected or transmitted to the respective photodetectors. The photodetectors generate a current roughly proportional to the amount of light falling upon it which is then fed through a resistor to generate a voltage. The amount of light reaching the photodetector depends upon the amount of coloured particulate label present and therefore the amount of analyte. Thus the amount of analyte present in the sample may be determined. This method of optically determining the analyte concentration is described more fully in EP 653625.

A sample may include, for example, anything which may contain an analyte of interest. The sample may be a biological sample, such as a biological fluid or a biological tissue. Examples of biological fluids include urine, blood, plasma, serum, saliva, semen, stool, sputum, cerebral spinal fluid, tears, mucus, amniotic fluid or the like. Biological tissues are aggregate of cells, usually of a particular kind together with their intercellular substance that form one of the structural materials of a human, animal, plant, bacterial, fungal or viral structure, including connective, epithelium, muscle and nerve tissues. Examples of biological tissues also include organs, tumors, lymph nodes, arteries and individual cells.

A fluid sample (e.g., biological fluid) may refer to a material suspected of containing the analyte(s) of interest, which material has sufficient fluidity to flow through an immunoassay device in accordance herewith. The fluid sample can be used as obtained directly from the source or following a pretreatment so as to modify its character. Such samples can include human, animal or man-made samples. The sample can be prepared in any convenient medium which does not interfere with the assay.

The fluid sample can be derived from any source, such as a physiological fluid, including blood, serum, plasma, saliva, sputum, ocular lens fluid, sweat, urine, milk, ascites fluid, mucous, synovial fluid, peritoneal fluid, transdermal exudates, pharyngeal exudates, bronchoalveolar lavage, tracheal aspirations, cerebrospinal fluid, semen, cervical mucus, vaginal or urethral secretions, amniotic fluid, and the like. Herein, fluid homogenates of cellular tissues such as, for example, hair, skin and nail scrapings, meat extracts and skins of fruits and nuts are also considered biological fluids. Pretreatment may involve preparing plasma from blood, diluting viscous fluids, and the like. Methods of treatment can involve filtration, distillation, separation, concentration, inactivation of interfering components, and the addition of reagents. Besides physiological fluids, other samples can be used such as water, food products, soil extracts, and the like for the performance of industrial, environmental, or food production assays as well as diagnostic assays. In addition, a solid material suspected of containing the analyte can be used as the test sample once it is modified to form a liquid medium or to release the analyte.

Exemplary lateral flow devices include those described in U.S. Pat. Nos. 4,818,677, 4,943,522, 5,096,837 (RE 35,306), 5,096,837, 5,118,428, 5,118,630, 5,221,616, 5,223,220, 5,225,328, 5,415,994, 5,434,057, 5,521,102, 5,536,646, 5,541,069, 5,686,315, 5,763,262, 5,766,961, 5,770,460, 5,773,234, 5,786,220, 5,804,452, 5,814,455, 5939,331, 6,306,642.

A sample may include, for example, anything which may contain an analyte. The sample may be a biological sample, such as a biological fluid or a biological tissue. Examples of biological fluids include urine, blood, plasma, serum, saliva, semen, stool, sputum, cerebral spinal fluid, tears, mucus, amniotic fluid or the like. Biological tissues are aggregate of cells, usually of a particular kind together with their intercellular substance that form one of the structural materials of a human, animal, plant, bacterial, fungal or viral structure, including connective, epithelium, muscle and nerve tissues. Examples of biological tissues also include organs, tumors, lymph nodes, arteries and individual cell(s). A liquid sample may refer to a material suspected of containing the analyte(s) of interest, which material has sufficient fluidity to flow through an immunoassay device in accordance herewith. The fluid sample can be used as obtained directly from the source or following a pretreatment so as to modify its character. Such samples can include human, animal or man-made samples. The sample can be prepared in any convenient medium which does not interfere with the assay. Typically, the sample is an aqueous solution or biological fluid as described in more detail below.

The fluid sample can be derived from any source, such as a physiological fluid, including blood, serum, plasma, saliva, sputum, ocular lens fluid, sweat, urine, milk, ascites fluid, mucous, synovial fluid, peritoneal fluid, transdermal exudates, pharyngeal exudates, bronchoalveolar lavage, tracheal aspirations, cerebrospinal fluid, semen, cervical mucus, vaginal or urethral secretions, amniotic fluid, and the like. Herein, fluid homogenates of cellular tissues such as, for example, hair, skin and nail scrapings, meat extracts and skins of fruits and nuts are also considered biological fluids. Pretreatment may involve preparing plasma from blood, diluting viscous fluids, and the like. Methods of treatment can involve filtration, distillation, separation, concentration, inactivation of interfering components, and the addition of reagents. Besides physiological fluids, other samples can be used such as water, food products, soil extracts, and the like for the performance of industrial, environmental, or food production assays as well as diagnostic assays. In addition, a solid material suspected of containing the analyte can be used as the test sample once it is modified to form a liquid medium or to release the analyte.

An analyte can be any substance for which there exists a naturally occurring analyte specific binding member or for which an analyte-specific binding member can be prepared. e.g., carbohydrate and lectin, hormone and receptor, complementary nucleic acids, and the like. Further, possible analytes include virtually any compound, composition, aggregation, or other substance which may be immunologically detected. That is, the analyte, or portion thereof, will be antigenic or haptenic having at least one determinant site, or will be a member of a naturally occurring binding pair.

Analytes include, but are not limited to, toxins, organic compounds, proteins, peptides, microorganisms, bacteria, viruses, amino acids, nucleic acids, carbohydrates, hormones, steroids, vitamins, drugs (including those administered for therapeutic purposes as well as those administered for illicit purposes), pollutants, pesticides, and metabolites of or antibodies to any of the above substances. The term analyte also includes any antigenic substances, haptens, antibodies, macromolecules, and combinations thereof (see, e.g., U.S. Pat. Nos. 4,366,241; 4,299,916; 4,275,149; and 4,806,311).

In an embodiment, a sample receiving zone on the surface of a lateral flow assay test strip accepts a fluid sample that may contain one or more analytes of interest. In an embodiment, the sample receiving zone is dipped into a fluid sample. A label zone is located downstream of the sample receiving zone, and contains one or more mobile label reagents that recognize, or are capable of binding the analytes of interest. Further, a test region may be disposed downstream from the label zone, and contains test and control zones. The test zone(s) generally contain means which permit the restraint of a particular analyte of interest in each test zone. Frequently, the means included in the test zone(s) comprise an immobilized capture reagent that binds to the analyte of interest. Generally the immobilized capture reagent specifically binds to the analyte of interest. Thus, as the fluid sample flows along the matrix, the analyte of interest will first bind with a mobilizable label reagent in the label zone, and then become restrained in the test zone.

In an embodiment, the sample receiving zone may be comprised of an absorbent application pad. Suitable materials for manufacturing absorbent application pads include, but are not limited to, hydrophilic polyethylene materials or pads, acrylic fiber, glass fiber, filter paper or pads, desiccated paper, paper pulp, fabric, and the like. For example, the sample receiving zone may be comprised of a material such as a nonwoven spunlaced acrylic fiber.

The sample receiving zone may be comprised of any material from which the fluid sample can pass to the label zone. Further, the absorbent application pad can be constructed to act as a filter for cellular components, hormones, particulate, and other certain substances that may occur in the fluid sample. Application pad materials suitable for use by the present invention also include those application pad materials disclosed in U.S. Pat. No. 5,075,078.

In a further embodiment, the sample receiving zone may be comprised of an additional sample application member (e.g., a wick). Thus, in one aspect, the sample receiving zone can comprise a sample application pad as well as a sample application member. Often the sample application member is comprised of a material that readily absorbs any of a variety of fluid samples contemplated herein, and remains robust in physical form. Frequently, the sample application member is comprised of a material such as white bonded polyester fiber. Moreover, the sample application member, if present, is positioned in fluid-flow contact with a sample application pad.

In an embodiment, the label zone material may be treated with labeled solution that includes material-blocking and label-stabilizing agents. Blocking agents include, for example, bovine serum albumin (BSA), methylated BSA, casein, nonfat dry milk. Stabilizing agents are readily available and well known in the art, and may be used, for example, to stabilize labeled reagents.

The label zone may contain a labeled reagent, often comprising one or more labeled reagents. In many of the presently contemplated embodiments, multiple types of labeled reagents are incorporated in the label zone such that they may permeate together with a fluid sample contacted with the device. These multiple types of labeled reagent can be analyte specific or control reagents and may have different detectable characteristics (e.g., different colors) such that one labeled reagent can be differentiated from another labeled reagent if utilized in the same device. As the labeled reagents are frequently bound to a specific analyte of interest subsequent to fluid sample flow through the label zone, differential detection of labeled reagents having different specificities (including analyte specific and control labeled reagents) may be a desirable attribute. However, frequently, the ability to differentially detect the labeled reagents having different specificities based on the label component alone is not necessary due to the presence of test and control zones in the device, which allow for the accumulation of labeled reagent in designated zones.

The labeling zone may also include control-type reagents. These labeled control reagents often comprise detectible moieties that will not become restrained in the test zones and that are carried through to the test region and control zone(s) by fluid sample flow through the device. In a frequent embodiment, these detectible moieties are coupled to a member of a specific binding pair to form a control conjugate which can then be restrained in a separate control zone of the test region by a corresponding member of the specific binding pair to verify that the flow of liquid is as expected. The visible moieties used in the labeled control reagents may be the same or different color, or of the same or different type, as those used in the analyte of interest specific labeled reagents. If different colors are used, ease of observing the results may be enhanced.

The test region may include a control zone for verification that the sample flow is as expected. Each of the control zones comprise a spatially distinct region that often includes an immobilized member of a specific binding pair which reacts with a labeled control reagent. In an occasional embodiment, the procedural control zone contains an authentic sample of the analyte of interest, or a fragment thereof. In this embodiment, one type of labeled reagent can be utilized, wherein fluid sample transports the labeled reagent to the test and control zones; and the labeled reagent not bound to an analyte of interest will then bind to the authentic sample of the analyte of interest positioned in the control zone. In another embodiment, the control line contains antibody that is specific for, or otherwise provides for the immobilization of, the labeled reagent. In operation, a labeled reagent is restrained in each of the one or more control zones, even when any or all the analytes of interest are absent from the test sample.

Since the devices of the present invention may incorporate one or more control zones, the labeled control reagent and their corresponding control zones are preferably developed such that each control zone will become visible with a desired intensity for all control zones after fluid sample is contacted with the device, regardless of the presence or absence of one or more analytes of interest. In one embodiment, a single labeled control reagent will be captured by each of the control zones on the test strip. Frequently, such a labeled control reagent will be deposited onto or in the label zone in an amount exceeding the capacity of the total binding capacity of the combined control zones if multiple control zones are present. Accordingly, the amount of capture reagent specific for the control label can be deposited in an amount that allows for the generation of desired signal intensity in the one or more control zones, and allows each of the control zones to restrain a desired amount of labeled control-reagent. At the completion of an assay, each of the control zones preferably provide a desired and/or pre-designed signal (in intensity and form).

In an embodiment, each control zone will be specific for a unique control reagent. In this embodiment, the label zone may include multiple and different labeled control reagents, equaling the number of control zones in the assay, or a related variation. Wherein each of the labeled control reagents may become restrained in one or more pre-determined and specific control zone(s). These labeled control reagents can provide the same detectible signal (e.g., be of the same color) or provide distinguishable detectible signals (e.g., have different colored labels or other detection systems) upon accumulation in the control zone(s).

In an embodiment, the labeled control reagent comprises a detectible moiety coupled to a member of a specific binding pair. Typically, a labeled control reagent is chosen to be different from the reagent that is recognized by the means which are capable of restraining an analyte of interest in the test zone. Further, the labeled control reagent is generally not specific for the analyte. In a frequent embodiment, the labeled control reagent is capable of binding the corresponding member of a specific binding pair or control capture partner that is immobilized on or in the control zone. Thus the labeled control reagent is directly restrained in the control zone.

The use of a control zone is helpful in that appearance of a signal in the control zone indicates the time at which the test result can be read, even for a negative result. Thus, when the expected signal appears in the control line, the presence or absence of a signal in a test zone can be noted.

Test zones of the present description include means that permit the restraint of an analyte of interest. Frequently, test zones of the present description include a ligand that is capable of specifically binding to an analyte of interest. Alternatively, test zones of the present description include a ligand that is capable of specifically binding the labeled reagent bound to an analyte of interest. In practice, a labeled test reagent binds an analyte of interest present in a fluid sample after contact of the sample with a representative device and flow of the fluid sample into and through the label zone. Thereafter, the fluid sample containing the labeled analyte progresses to a test zone and becomes restrained in the test zone. The accumulation of labeled analyte in the test zone produces a detectible signal. Devices may incorporate one or more test zones, each of which is capable of restraining different analytes, if present, in a fluid sample. Thus, in representative embodiments two, three, four, five or more (labeled) analytes of interest can be restrained in a single or different test zones, and thereby detected, in a single device.

The present devices may optionally further comprise an absorbent zone that acts to absorb excess sample after the sample migrates through the test region. The absorbent zone, when present lies in fluid flow contact with the test region. This fluid flow contact can comprise an overlapping, abutting or interlaced type of contact. In an occasional embodiment, a control region (end of assay indicator) is provided in the absorbent zone to indicate when the assay is complete. In this embodiment, specialized reagents are utilized, such as pH sensitive reagents (such as bromocresol green), to indicate when the fluid sample has permeated past all of the test and control zones.

The test strip optionally may be contained within a housing for insertion into the reflectance reader. The housing may be made of plastic or other inert material that does not interfere with the assay procedure.

The lateral flow assay test strip may be suited for use with a reading device that comprises one or more of the following: a central processing unit (CPU) or microcontroller; two or more LED's; two or more photodiodes; a power source; and associated electrical circuitry. The power source may comprise a battery or any other suitable power source (e.g. a photovoltaic cell). The CPU will typically be programmed so as to determine whether the calculated rate and/or extent of progress of the liquid sample is within predetermined limits.

Conveniently the assay result reading device will comprise some manner of indicating the result of the assay to a user. This may take the form, for example, of an audible or visible signal. Desirably the device will comprise a visual display to display the assay result. This may simply take the form of one or more LED's or other light sources, such that illumination of a particular light source or combination of light sources conveys the necessary information to the user. Alternatively the device may be provided with an alphanumeric or other display, such as an LCD. In addition, or as an alternative, to displaying the assay result, the device may also display or indicate in some other way to the user whether the calculated rate and/or extent of progress of the liquid sample is within the predetermined acceptable limits, and thus whether or not the result of the particular assay should be disregarded. If the reading device determines that a particular assay result should be disregarded it may prompt the user to repeat the assay.

Any device which is compatible for use with an assay test strip, preferably a reflectance reader, for determining the assay result is contemplated for use herein. Such test strip devices as are known to those of skill in the art (see, e.g., U.S. Pat. Nos. 5,658,801, 5,656,502, 5,591,645, 5,500,375, 5,252,459, 5,132,097). Reflectance and other readers, including densitometers and transmittance readers, are known to those of skill in the art (see, e.g., U.S. Pat. Nos. 5,598,007, 5,132,097, 5,094,955, 4,267,261, 5,118,183, 5,661,563, 4,647,544, 4,197,088, 4,666,309, 5,457,313, 3,905,767, 5,198,369, 4,400,353).

It should be understood by those skilled in the art that various modifications, combinations, sub-combinations and alterations may occur depending on design requirements and other factors insofar as they are within the scope of the appended claims or the equivalents thereof.

1. A device comprising:
a light source for illumination of a labeling material;
a photodetector that detects a light absorbed or released from the labeling material;
a first analog switch that is turned on at a first time for a finite interval after the light source is enabled, receives a signal from the photodetector and generates a first signal;
a second analog switch that is turned on at a second time for a finite interval after the light source is disabled, receives a signal from the photodetector and generates a second signal; and
a differential amplifier that receives the first signal and the second signal and produces an output signal.

2. The device of claim 1 further comprising a transimpedance amplifier for amplifying the signal produced by the photodetector.

3. The device of claim 1 further comprising an RC filter network after the first switch to detect the test light.

4. The device of claim 1 further comprising an RC filter network after the second switch to detect the background noise.

5. The device of claim 1 further comprising an RC filter network after the first switch and after the second switch.

6. The device of claim 1 further comprising a resistor after the transimpedance amplifier.

7. The device of claim 1 further comprising an analog to digital converter and a microcontroller to drive a user friendly interface.

8. The device of claim 1, wherein the user friendly interface is an LCD display.

9. The device of claim 1 further comprising a capacitor across the input of the differential amplifier.

10. The device of claim 1 further comprising a light source for excitation of the labeling material.

11. The device of claim 1, wherein the light source is a laser.

12. The device of claim 1, wherein the light source is a LED.

13. The device of claim 1, wherein the photodetector is a PIN photo diode.

14. The device of claim 1, wherein the first analog switch receives a signal from the detector corresponding to the light absorbed or released from a labeling material.

15. The device of claim 1, wherein the second analog switch receives a signal from the detector corresponding to background signal.

16. The device of claim 1, wherein the background signal is selected from the group consisting of: background light, dark current of the PIN diode, noise of the electronics used to drive the light source, and the noise of the electronic circuitry of the detector and amplifiers or combinations thereof.

17. The device of claim 1, wherein the labeling material is a fluorescent material.

18. The device of claim 1, wherein the labeling material is a reflective material.

19. A method for detecting a light absorbed or released from a labeling material, the method comprising:
contacting a labeling material with a light source, wherein the fluorescent label absorbs or releases a first light;
detecting the first light with a detector after the light source is enabled, wherein the detector produces a first signal from the first light;
turning on a first switch at a first time for a finite interval to receive the first signal from the first light;
detecting a background signal with a detector after the light source is disabled, wherein the detector produces a second signal from the background signal;
turning on a second switch at a second time for a finite interval to receive the second signal from the second light;
feeding the first signal and the second signal into a differential amplifier, wherein the differential amplifier subtracts the second signal from the first signal and produces an output signal; and
measuring the output signal emitted from the differential amplifier.

20. The method of claim 19, wherein the first switch detects the light absorbed or released from the labeling material.

21. The method of claim 19, wherein the background signal is selected from the group consisting of: background light, dark current of the PIN diode, noise of the electronics used to drive the light source, and the noise of the electronic circuitry of the detector and amplifiers or combinations thereof.

22. The method of claim 19, wherein the labeling material is a fluorescent material.

23. The method of claim 19, wherein the labeling material is a reflective material.

24. The method of claim 19, wherein the test light and the background light are detected by the same detector.

25. The method of claim 19, wherein the test light and the background light are detected by different detectors.

26. The method of claim 19, wherein the light source is a laser.

27. The method of claim 19, wherein the light source is a LED.

28. The method of claim 19, wherein the light is pulsed.

29. The method of claim 19, wherein the first switch is opened during fluorescence decay.

30. The method of claim 19, wherein the second switch is opened before or after the fluorescent label is contacted with the light source.

31. The method of claim 19, wherein the output of the first and the second analog switches are fed into low-pass RC filters.

32. The method of claim 19, wherein a third filter is added across the inputs of the amplifier for further filtering.

33. A method for conducting an assay, the method comprising:
applying a test sample with at least one analyte to the assay;
binding a labeling material to the analyte;
contacting the labeling material with a light source, wherein the labeling material absorbs or releases a first light;
detecting the first light with a detector after the light source is enabled, wherein the detector produces a first signal from the first light;
turning on a first switch at a first time for a fixed interval to receive the first signal from the first light;
detecting background noise with a detector after the light source is disabled, wherein the detector produces a second signal from the background noise;
turning on a second switch at a second time for a fixed interval to receive the second signal from the second light;
feeding the first signal and the second signal into a differential amplifier, wherein the differential amplifier subtracts the second signal from the first signal and produces an output signal; and
measuring the output signal emitted from the differential amplifier.

34. The method of claim 33, wherein the assay is a lateral flow assay.

35. The method of claim 33, wherein the first switch detects the light absorbed or released from the fluorescent label.

36. The method of claim 33, wherein the background noise is selected from the group consisting of: background light, dark current of the PIN diode, noise of the electronics used to drive the light source, and the noise of the electronic circuitry of the detector and amplifiers or combinations thereof.

37. The method of claim 33, wherein the labeling material is a fluorescent material.

38. The method of claim 33, wherein the labeling material is a reflective material.

39. The method of claim 33, wherein the test light and the background light are detected by the same detector

40. The method of claim 33, wherein the test light and the background light are detected by different detectors.

41. The method of claim 33, wherein the light source is a laser.

42. The method of claim 33, wherein the light source is a LED.

43. The method of claim 33, wherein the light is pulsed.

44. The method of claim 33, wherein the first switch is opened during fluorescence decay.

45. The method of claim 33, wherein the second switch is opened before or after the fluorescent label is contacted with the light source.

46. The method of claim 33, wherein the output of the first and the second analog switches are fed into low-pass RC filters.

47. The method of claim 33, wherein a third filter is added across the inputs of the amplifier for further filtering.
